(19) United States
(12) Patent Application Publication
(10) Pub. No.: US 2007/0188757 A1
(43) Pub. Date: Aug. 16, 2007

(54) Method of sealing a glass envelope

(76) Inventors: Jeffrey Michael Amsden, Hammondsport, NY (US); Puthiya Kottal Saquib Mohamed, Thana Kannur (IN); Aiyu Zhang, Mason, OH (US)

Correspondence Address: CORNING INCORPORATED, SP-TI-3-1, CORNING, NY, 14831, US

(21) Appl. No.: 11/605,878

(22) Filed: Nov. 28, 2006

Related U.S. Application Data
(60) Provisional application No. 60/773,399, filed on Feb. 14, 2006.

(51) Int. Cl. G01B 11/00

(52) U.S. Cl. 356/401

(57) ABSTRACT

A method of sealing a glass package comprising providing a first glass substrate, the first substrate having first and second alignment marks. A second glass substrate having third and fourth alignment marks is aligned to the first substrate by translating the first substrate relative to the second substrate, and aligning the second and fourth alignment marks by rotating the first substrate relative to the second substrate.

### CROSS-REFERENCE TO RELATED APPLICATIONS

This application claims the benefit of priority under 35 U.S.C. §119(e) of U.S. Provisional Application Ser. No. 60/773399 filed on 14 Feb. 2006, the contents of which are incorporated herein by reference in their entirety.

### BACKGROUND OF THE INVENTION

1. Field of the Invention

The present invention relates generally to sealing a glass envelope, and particularly to sealing glass substrates with a frit.

2. Technical Background

Organic light emitting diode displays offer an attractive alternative to LCD and plasma based display technologies. However, the organic light emitting elements of the display devices are susceptible to damage from exposure to moisture (humidity) and oxygen, and therefore must be hermetically sealed within an appropriate envelope to prevent exposure to such environmental hazards. The hermetic seal must be robust enough to protect the organic material over the lifetime of the device incorporating the display (e.g. television, cell phone, etc.).

Glass envelopes are an ideal container in which to encase the OLED device. Such envelope may be sealed using an epoxy, or other adhesive material, but more recently, sealing via a glass frit disposed between the substrates comprising the display has proven to be a desirable alternative, owing at least in part to the hermetic nature of the glass seal formed by the frit. Nevertheless, as the applications for OLED displays increase in size, from camera and cell phone screens to larger devices, such as televisions, the size of the substrates used to manufacture such devices must also increase in size to provide the necessary economies of scale. That is, equipment manufacturers typically deposit a plurality of display devices between two substrate, seal the substrates, then separate (divide) the sealed substrates into a plurality of finished display devices. Hermetically sealing a plurality of OLED display devices between two substrates repeatedly, with a high degree of precision, has proven challenging.

As described above, because the organic layers of the OLED display device are susceptible to damage from heat, the frit used to form the seal between the glass substrates cannot be heated in an oven, since the heat would be applied equally to the frit and to the organic materials. Sealing the frit by traversing the frit with a laser, thereby heating the frit and forming the hermetic seal is the desired approach.

A current method of laser sealing alignment is to align the laser to each cell (each frit frame) manually prior to sealing, which is time consuming and has potential for human error. This manual process also relies on the edges of the substrates as markers for alignment. The lateral and rotational tolerance of the cells containing the OLED devices with respect to the substrate edges and fritted cover sheets is not repeatable enough for the glass edges to be used for alignment of large size substrates containing a multiplicity of OLED devices. As the size and/or number of cells per substrate increases, and hence the size of the sheets, the need to align the entire substrate to the fritted cover sheet becomes critical for efficiency, precision and yield. The alignment of the OLED devices to the frit forming each cell is critical to ensure the hermeticity of the seal

In some processes magnets have been used as a method to apply a force between the OLED-containing substrate and the fritted cover sheet during laser sealing. However, magnets are not practical for large substrate sizes. In addition, magnets have been identified as an enhancer of Newton's Rings within sealed substrates due to their non-uniform force on the substrates. A process and equipment that applies a uniform repeatable force over the entire substrate, and which is capable of repeatable, precise alignment of the substrate components is therefore desirable.

### SUMMARY OF THE INVENTION

In accordance with an embodiment of the present invention, a method of sealing a glass envelope is disclosed comprising a first glass substrate having first and second alignment marks. A second glass substrate having third and fourth alignment marks, and comprising at least one frit wall disposed thereon, is aligned to the first substrate by translating the first substrate relative to the second substrate, and aligning the second and fourth alignment marks by rotating the first substrate relative to the second substrate. The translating is accomplished along one or both of orthogonal axes in the plane of the first substrate. The resulting stack is then sealed by heating and melting the at least one frit wall with a laser.

In another embodiment, a method of sealing a glass envelope is provided comprising positioning a first substrate comprising first and second alignment marks on an alignment table having an axis of rotation such that the axis of rotation passes through the first alignment mark, positioning a second substrate comprising third and fourth alignment marks over the first substrate, the second substrate including a frit deposited thereon, aligning the first alignment mark with the third alignment mark, rotating the first substrate about the axis of rotation to align the second alignment mark with the fourth alignment mark, and heating the frit with a laser beam to melt the frit and form a hermetic seal between the first and second substrates

In still another embodiment, an apparatus for assembling and sealing a glass envelope is disclosed comprising a rotatably mounted alignment table for receiving a substrate, the alignment table being movable along x and y directions in a plane, the x and y directions being mutually orthogonal, a substrate transporter for transporting the first substrate to the alignment table and a laser sealing system for sealing a second substrate having a frit deposited thereon to the first substrate.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate an exemplary embodiment of the invention, and together with the description serve to explain the principles and operations of the invention.

### BRIEF DESCRIPTION OF THE DRAWINGS

FIG. 1 is a perspective view of an apparatus for assembling and sealing glass substrates to form a glass envelope according to an embodiment of the present invention;

FIG. 2 is an top-down illustration of the movement (translation and rotation) of a first substrate relative to a second substrate using alignment marks to align the first and second substrates.

FIG. 3 is a top view of first and second substrates, showing exemplary positioning of OLED devices and frit walls, and exemplary positioning of alignment marks.

FIG. 4 is a cross sectional view of a first substrate having OLED devices disposed thereon, and it's positioning relative to a second substrate having frit walls disposed thereon, prior to final assembly and sealing.

FIG. 5 is a perspective view of an apparatus for assembly and sealing of glass substrates to form a glass envelope

FIG. 6 is a partial perspective view of the apparatus of FIG. 5 showing the rail and sealing systems.

FIG. 7 is a diagrammatic view of an assembly and sealing system in accordance with an embodiment of the present invention

### DETAILED DESCRIPTION OF THE PREFERRED EMBODIMENTS

Reference will now be made in detail to the present preferred embodiment of the invention, an example of which is illustrated in the accompanying drawings. Whenever possible, the same reference numerals will be used throughout the drawings to refer to the same or like parts.

Organic light emitting diode (OLED) display devices typically comprise at least a first substrate including organic light emitting layers disposed thereon. This first substrate is often referred to as the backplane. A second, transparent, substrate is then placed overtop the backplane, with a sealing material disposed between the first and second substrates to create a hermetically sealed package with the OLEDs disposed therein. The substrates themselves are typically less than about 1 mm in thickness, but more generally less than about 0.7 mm in thickness. The seal may be an epoxy seal, or, in some cases, the seal may be a glass seal formed by a frit material disposed between the two substrates. In the instance of a frit seal, a frit paste is first deposited onto the cover substrate in a pre-determined pattern matching generally the pattern of deposited OLED devices on the first substrate, and then pre-sintered by heating the frit to a sintering temperature, to sinter the frit and burn off organic binders in frit. To improve manufacturing efficiencies, the backplane may include a plurality of individual OLED display devices disposed thereon in an array. When the substrates are assembled, each OLED display device of the array of display devices is encapsulated between the backplane, the cover and a frame-shaped wall of frit. After the substrates are sealed, the individual OLED display devices may be cut from the sealed parent substrates to form separate OLED displays.

In some instances where frit sealing is performed, a temporary mask having transparent regions coinciding with the frit patterns on the cover substrate may be placed over the cover substrate to ensure that the laser used to heat and melt the frit and seal the first substrate to the second substrate does not accidentally also heat any of the organic materials used to form the OLED device. Such organic materials are intolerant of the high temperatures used to melt the frit, and may be damaged or destroyed if contacted by the laser light. If used, the mask must also be aligned precisely to the cover substrate to ensure a proper hermetic seal is made around each individual OLED display device.

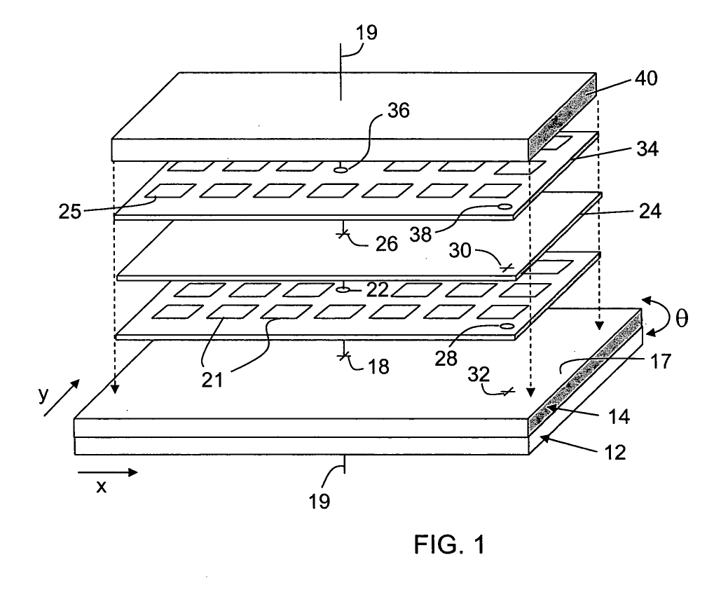

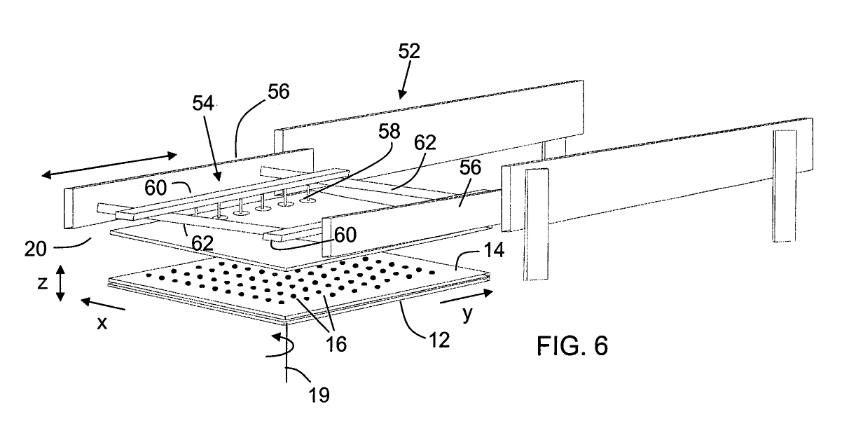

In accordance with an embodiment of the present invention illustrated in FIG. 1, an assembly and sealing apparatus is provided, referred to generally by the reference numeral 10. Assembly and sealing apparatus 10 comprises alignment table 12, further comprising a vacuum chuck 14 having a plurality of orifices 16 (see FIG. 6) opening on surface 17 and connected to a vacuum source (not shown). Orifices 16 have been omitted from FIG. 1 so as not to obscure other details. Vacuum chuck 14 may be an integral part of alignment table 12, or vacuum chuck 14 may be mounted on alignment table 12. In any event, alignment table 12 and vacuum chuck 14 are preferably secured one to the other and move as a unit. Surface 17 of the vacuum chuck includes an alignment mark 18 to facilitate placement of a backplane substrate thereon. As depicted in the figures, the alignment marks are circles and crosshairs, but may be other shapes, such as dots. Alignment table 12 is adapted such that the alignment is capable of movement in both the “x” and “y” directions, where the x and y directions define a plane parallel with surface 17 of vacuum chuck 14. Alignment table 12 is also capable of rotation about a z axis 19 within the xy plane, z axis 19 being also perpendicular to the xy plane. Preferably, the vacuum chuck alignment mark 18 is coincident with the z rotational axis 19 of alignment table 12.

Backplane substrate 20, comprising a plurality of OLED devices 21 disposed thereon, is positioned over vacuum chuck 14, and vacuum chuck alignment mark 18 aligned with a first alignment mark 22 on backplane substrate 20. This may be conveniently accomplished by moving alignment table 12 in either or both of the “x” and “y” directions until alignment mark 18 on vacuum chuck 14 is aligned with alignment mark 22 on backplane substrate 20. After alignment of backplane substrate alignment mark 22 with vacuum chuck alignment mark 18, backplane substrate 20 and vacuum chuck 14 are brought into contact, and a vacuum is applied to the vacuum chuck, securing backplane substrate 22 to chuck 14.

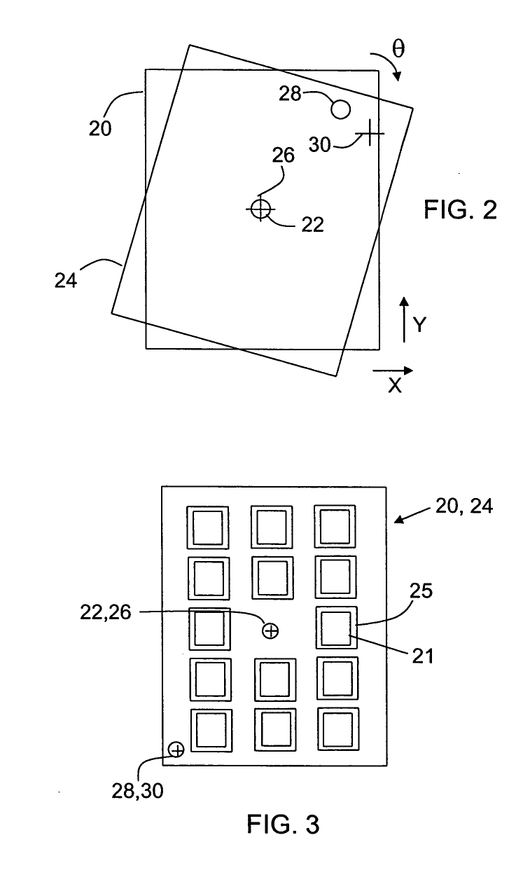

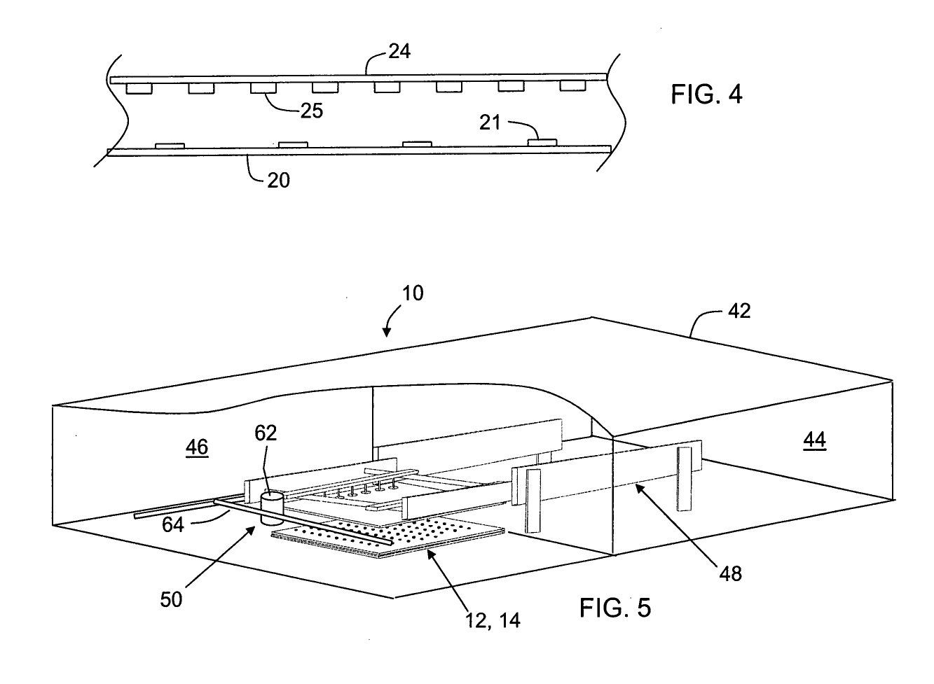

Following placement of backplane substrate 20 onto vacuum chuck 14, cover substrate 24, comprising a plurality of frame-shaped frit walls 25 (see FIGS. 3, 4), is positioned over the backplane substrate. Alignment table 12 is translated in either or both of the x and y directions until a first alignment mark 26 on cover substrate 24 is aligned with alignment mark 22 on backplane substrate 20. Once alignment marks 22 and 26 are aligned, alignment table 12 is rotated about axis 19 until a second alignment mark 28 on backplane substrate 20 is aligned with a corresponding second alignment mark 30 on cover substrate 24. This process is illustrated in FIG. 2, indicating translation of backplane substrate 20 according to the “x” and “y” arrows, until alignment marks 22, 26 are aligned, then rotation of backplane substrate 20 (via alignment table 12) through an angle θ until alignment marks 28, 30 are centered one with the other. Note that the pattern of OLED devices and frit patterns on the backplane and cover substrates, respectively, have been omitted so as not to obscure other details of FIG. 2. After backplane substrate 20 and cover substrate 24 are aligned and brought into contact, OLED devices 21 are circumscribed by the frit walls 25. This is depicted more clearly in FIGS. 3-4. FIG. 3 shows a top view of cover substrate 24 overlayed on backplane substrate 20 after alignment of the substrates and depicts OLED devices 21 within the boundaries of frit walls 25. FIG. 4 illustrates a partial cross section of backplane substrate 20 and cover substrate 24, and also illustrates OLED devices 21 and frit walls 25, just prior to bringing the fritted cover substrate into contact with the backplane substrate.

Once alignment mark pairs 22, 26 and 28, 30 are aligned, fritted cover substrate 24 may be brought into contact with backplane substrate 20 and secured in place, such as by clamping. Clamping may be accomplished by any appropriate means that will not interfere with the sealing process, and which does not damage the OLED devices disposed between the backplane and cover substrates.

While not necessary, vacuum chuck 14 may include second alignment mark 32 such that backplane substrate 20 may be aligned with vacuum chuck 14 in a manner as disclosed above for cover substrate 24. That is, prior to securing backplane substrate 20 to vacuum chuck 14, but after moving alignment table 12 in one or both of the x and y directions to align alignment mark 18 with alignment mark 22, rotating alignment table 12 until alignment mark 32 on vacuum chuck 14 is alignment with alignment mark 28 on backplane substrate 20.

If optional sealing laser mask 34 is to be used, mask 34 is positioned and aligned similarly to the process described above. Mask 34 is positioned over the stacked substrates 20, 24. Alignment table 12 is then translated in either or both of the x and y directions until alignment marks 22, 26 are aligned with a first alignment mark 36 on the mask. Alignment table 12 is then rotated until alignment marks 28, 30 are aligned with a second alignment mark 38 on mask 34. Mask 34 is then brought into contact with cover substrate 24, and secured in place.

To ensure proper sealing, pressure plate 40 may also be applied to the stack of aligned substrates. The pressure plate may be a simple, thick, substrate transparent to the wavelength of light from the sealing laser, which is placed overtop the aligned stack, and exerts a substantially uniform pressure on the stack through the action of gravity. By transparent what is meant is that the pressure plate will not absorb laser energy in an amount which impedes the sealing process. Since pressure plate 40 will not become a permanent part of the glass package, nor play a part in the sealing process beyond exerting pressure on the aligned stack, critical alignment of the pressure plate is not necessary, but may, if desired, be accomplished in the manner described above, if appropriate alignment marks are included on pressure plate 40.

Once the stack is assembled, the first, backplane substrate, and the second, cover substrate may be sealed by traversing the frit disposed between the backplane and cover substrates with a laser beam to heat the frit. The heated frit melts and forms a hermetic seal between the backplane and cover substrates. The laser beam is directed at the frit through the cover substrate, the optional mask, if used, and the pressure plate. Consequently, it is desirable that the cover substrate, and the pressure plate are substantially transparent to the wavelength of light emitted by the laser. Those portions of the mask conforming to the frit placement should also be substantially transparent to the wavelength of the laser beam.

Is it preferable that alignment of one alignment mark to another alignment mark is accomplished to within ±20 μm, i.e. the distance between the center of one alignment mark and the center of another alignment mark aligned to the preceding alignment mark should not exceed 20 μm. To that end, it should be appreciated that the steps described supra may be automated such that the method may be carried out quickly, rapidly and precisely. For example, FIG. 5 illustrates additional elements which may be used with exemplary apparatus 10 for carrying out the assembly and sealing method described above. Apparatus 10 may further include a preparation and sealing chamber 42 comprising a preparation portion 44 and a sealing portion 46, the preparation portion and the sealing portion being joined such that substrates prepared in the preparation portion may be freely transported between the preparation portion and the sealing portion. Preferably the preparation and sealing chamber 42 is capable of being hermetically sealed such that an atmosphere appropriate to the sealing process may be maintained within the chambers. For example, the preparation and sealing chamber atmosphere may be comprised primarily of an inert or noble gas such as nitrogen or argon.

Apparatus 10 may further include a substrate transporter system 48 and a laser sealing system 50, in addition to alignment table 12. Substrate transporter system 48 may utilize any known method of transporting thin substrate sheets from one location to another. As illustrated in FIG. 6, substrate transporter system 48 may include a raised rail system 52 which supports a vacuum-assisted substrate carrier assembly 54 which is attached to the rail system. In one particular embodiment, rail system 52 comprises extendable cantilevered arms 56 that allow the rail system to extend into sealing portion 46 from preparation portion 44. After delivering a component (e.g. a substrate) to the sealing chamber, the substrate carrier assembly attached to extendable arms 56 is retrieved back into preparation portion 44 by retracting extendable arms 56 from the sealing portion. Thus, it is intended that transporter system 48 will not interfere with laser sealing system 50.

Vacuum assistance on substrate carrier assembly 54 may be used to hold a substrate component which is to be added to the stack, such as the first (backplane) or second (cover) substrate, the pressure plate, etc. For example, the substrate carrier assembly may include one or more vacuum chucks 58 which may be used to secure the component to the substrate carrier assembly. When the first, backplane substrate is being secured to the substrate carrier assembly, it is desirable that the one or more vacuum chucks 58 do not contact any of the OLED devices disposed on the surface of the backplane substrate. Since the backplane substrate is typically the first component of the stack and the OLED devices will be disposed between the backplane substrate and the subsequent cover substrate, the OLED devices will be on the surface of the backplane substrate facing the substrate carrier assembly and vacuum chucks. Consequently, the one or more vacuum chucks 58 may be adjusted in position to avoid contact with the OLED devices. As shown in FIG. 6, vacuum chucks 58 are attached to support beams 60, which are in turn slidably connected to slide bars 62. For example, support beams 60 may be connected to slide bars 62 by bushings (not shown). This allows support beams 60 to be moved in a direction orthogonal to the direction of travel of extension arms 56 by sliding on slide bars 62, thereby allowing transporter system 48 to handle substrates having a variety of widths and/or OLED device patterns.

In contrast to the backplane substrate, the cover substrate will be oriented such that the surface of the cover substrate on which the frit is deposited will be facing away from the transport system. Thus, the vacuum chucks may contact the surface of the cover substrate opposite the frit-deposited surface, without concern for damaging the frit.

In accordance with the present embodiment, the backplane substrate will be moved by transporter system 48 from preparation portion 44 of chamber 42 to a position over the alignment table 12 in sealing portion 46 of chamber 42 with the OLED material facing up, avoiding contact with the OLED material. The transfer of the backplane substrate is facilitated by cantilevered rail system 52 to move the substrates via substrate carrier assembly 54 from preparation portion 44 of chamber 42 to sealing portion 46 of chamber 42. First alignment mark 22 on backplane substrate 20 is then aligned with alignment mark 18 on vacuum chuck 14.

In accordance with the present embodiment, alignment table 12 may also be capable of translation in the Z direction, i.e. parallel to the axis of rotation of the table. Consequently, once a substrate component, such as the backplane substrate, is properly positioned above alignment table 12, the alignment table is translated along the Z direction until the alignment table is in contact with the substrate. A vacuum is applied to the component substrate from vacuum chuck 14 mounted on alignment table 12 to secure the component substrate to the alignment vacuum chuck, and the vacuum to vacuum chucks 58 on transfer substrate carrier assembly 54 are released.

Assuming the transferred substrate described supra is the backplane substrate, the fritted cover substrate is secured to the retracted substrate carrier assembly and then moved from the preparation portion 44 of chamber 42 to a position over the backplane substrate in the sealing portion 46 with the frit material facing downward.

The fritted cover substrate is aligned with the backplane substrate, first by translating the backplane substrate via the alignment table in either or both of the x and y directions such that alignment mark 22 on backplane substrate 20 is aligned with alignment mark 26 on cover substrate 24. Alignment mark 18 preferably has the same center as the axis of rotation 19 of alignment table 12 so that once alignment mark 22 is aligned with alignment mark 26, subsequent alignment requires only a rotation of alignment table 12. Thus, once alignment marks 22, 26 are aligned, alignment table 12 is rotated until alignment mark 28 is aligned with alignment mark 30. Obviously, the distance between alignment marks 22 and 28 are the same as the distance between alignment marks 26 and 30, and alignment marks 26, 30 are arranged on cover substrate 24 such that when alignment marks 26 and 30 are aligned with alignment marks 22 and 28, respectively, cover substrate 24 is appropriately aligned with backplane substrate 20. Once cover substrate 24 is aligned with backplane substrate 20, cover substrate 24 is brought into contact with backplane substrate 20, and suitably clamped to backplane substrate 20. Cover substrate 24 is released from substrate carrier assembly 54 and the substrate carrier assembly and extension arms 56 are retracted from the sealing portion of chamber 42 into the preparation portion.

If mask 34 is to be used during the sealing process, the mask is positioned and aligned to the substrate stack in a manner consistent with the description above. The mask may consist of a substrate which is generally non-transmissive to the laser light used to seal the substrates, but which comprises transparent regions coinciding with the frit array on the cover substrate. For example, the mask may be formed by conventional vapor deposition methods. The mask may then be clamped into place on the stack. This is followed by positioning and alignment of the pressure plate with respect to the stack. In some embodiments, the pressure plate and mask may be a unitary structure, e.g. a thick plate of silica with appropriate transparent regions to facilitate sealing of the frit. That is, the pressure plate may include a photolithographic pattern which allows only selected transmission of an incident laser beam.

The entire stack, comprising backplane substrate 20 (with OLED display devices 21), fritted cover substrate 24, pressure plate 40 and optionally mask 34 is then aligned with laser sealing system 50 by rotating the alignment table until alignment mark 38 aligns with a reticle (not shown) in an alignment lens of the laser sealing system.

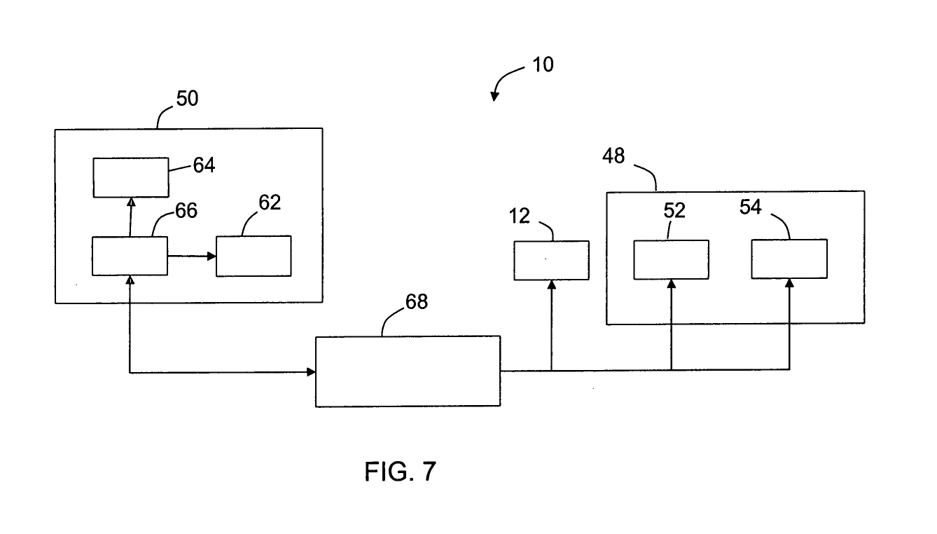

As depicted in FIG. 7, laser sealing system 50 includes laser 62, laser transport system 64, optical guidance system 66 and control computer 68. Laser 62 emits a laser light having a wavelength which is readily absorbed by the frit, but conversely easily transmitted by the cover substrate, the pressure plate, and the transparent regions of the optional mask substrate. For example, lasers emitting at a wavelength of 810 nm are commercially readily available and may be used in the sealing process. Laser transport system 64 is adapted such that laser 62 may be translated in both the “x” and “y” directions of a plane parallel with surface 17 of vacuum chuck 14, and the stacked substrates. For example, a conventional gantry system may be used. As shown in FIG. 7, an optical guidance system is connected with the computer and adapted via conventional machine vision software to move in reference to predetermined landmarks on the substrates to be sealed. For example, the optical guidance system may include a camera wherein the camera, in conjunction with computer 68, guides laser transport system 64 so that movement of laser 62 can be precisely controlled in accordance with a predetermined set of instructions programmed into the computer. This may be accomplished by focusing the camera on a predetermined point on the substrate stack, for example, an alignment mark, which may then serve as a reference point for all further movement of the laser. The computer then relays the appropriate instructions to the laser transport system to drive the laser in a predetermined pattern appropriate for a given frit pattern on cover substrate 24. The computer may further turn laser 62 on or off, or otherwise adjust the power of laser 62 as necessary to accomplish proper melting of the frit and sealing of the backplane substrate to the cover substrate.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of sealing a glass envelope comprising the steps of:
providing a first glass substrate, the first substrate having first and second alignment marks;
aligning a second glass substrate to the first substrate, the second substrate having third and fourth alignment marks, and comprising at least one frit wall disposed thereon;
sealing the first and second substrates by heating and melting the at least one frit wall with a laser; and
wherein the step of aligning comprises aligning the first and third alignment marks by translating the first substrate relative to the second substrate, and aligning the second and fourth alignment marks by rotating the first substrate relative to the second substrate.

2. The method according to claim 1 further comprising prior to the step of sealing, aligning a mask on the first and second substrates.

3. The method according to claim 2 further comprising disposing a transparent pressure plate over the mask.

4. The method according to claim 1 further comprising disposing a transparent pressure plate over the second substrate.

5. The method according to claim 4 wherein the pressure plate comprises a mask.

6. The method according to claim 1 further comprising placing the first substrate on a rotatable alignment table such that the first alignment mark is coincident with an axis of rotation of the alignment table.

7. The method according to claim 1 wherein the first substrate comprises at least one organic light emitting diode (OLED) device.

8. The method according to claim 1 wherein the alignment of the first and third alignment marks is within ±20 μm.

9. The method according to claim 1 wherein the alignment of the second and fourth alignment marks is within ±20 μm.

10. The method according to claim 6 further comprising constraining the first substrate to the alignment table by a vacuum.

11. The method according to claim 1 further comprising heating the at least one frit wall prior to the aligning step to sinter the frit wall.

12. A method of sealing a display device comprising:
positioning a first substrate comprising first and second alignment marks on an alignment table having an axis of rotation such that the axis of rotation passes through the first alignment mark;
positioning a second substrate comprising third and fourth alignment marks over the first substrate, the second substrate including a frit deposited thereon;
aligning the first alignment mark with the third alignment mark;
rotating the first substrate about the axis of rotation to align the second alignment mark with the fourth alignment mark; and
heating the frit with a laser beam to melt the frit and form a hermetic seal between the first and second substrates.

13. The method according to claim 12 further comprising constraining the first substrate on the alignment table by a vacuum.

14. The method according to claim 12 further comprising aligning a mask to the second substrate.

15. The method according to claim 12 further comprising disposing a pressure plate over the second substrate, the pressure plate being substantially transparent to a wavelength of the laser light.

16. The method according to claim 12 wherein the first substrate comprises at least one organic light emitting diode (OLED) device.

17. An apparatus for sealing a glass envelope comprising:
a rotatably mounted alignment table configured to be translated along at least two orthogonal directions, a first x direction and a second y direction;
a substrate transporter for transporting first and second substrates to the alignment table; and
a laser sealing system for sealing the second substrate to the first substrate.

18. The apparatus according to claim 17 wherein the alignment table is further movable in a z direction orthogonal to the x and y directions.

19. The apparatus according to claim 17 wherein the substrate transporter comprises extendable arms.

20. The apparatus according to claim 18 wherein the alignment table comprises a vacuum chuck for securing the first substrate to the alignment table.
